(19) United States
(12) Patent Application Publication
(10) Pub. No.: US 2013/0204787 A1
(43) Pub. Date: Aug. 8, 2013

(54) AUTHENTICATION & AUTHORIZATION OF TRANSACTIONS USING AN EXTERNAL ALIAS

(71) Applicant: Pieter Dubois, Korbeek-Lo (BE)

(72) Inventor: Pieter Dubois, Korbeek-Lo (BE)

(21) Appl. No.: 13/759,063

(22) Filed: Feb. 5, 2013

(30) Foreign Application Priority Data
Feb. 3, 2012 (BE) EP12153943.1

(51) Int. Cl. G06Q 20/40

(52) U.S. Cl. CPC G06Q 20/40
USPC 705/44

(57) ABSTRACT

Described herein is a transaction system (100) in which a transaction is authenticated using an external alias. When procuring an item from a supplier (120), a customer (110) needs to provide payment in some form or the other. Profiles relating to both the customer (110) and the supplier (120) are stored in an environment managed by a broker (130) and payment is effected by transfer of within that environment from a customer wallet to a supplier wallet. The customer (120) is represented as an alias as far as the supplier (120) is concerned, whereby the alias is provided by an external identity provider (140) such as a social network with which the customer (120) is associated. The anonymity of the customer (120) is maintained with respect to the supplier (120).

### RELATED U.S. PUBLICATION DATA

This patent application is a non-provisional of and claims priority to U.S. provisional patent application 61/595,099 filed Feb. 5, 2012 under attorney docket 8043501/Gevers/Paycento

### FIELD OF THE INVENTION

The present invention relates to authentication and authorizations of transactions using an external alias, more particularly using a social network identity.

### BACKGROUND TO THE INVENTION

Payments using electronic networks tend to be used a great deal nowadays, especially for smaller values. A typical transaction costs at least 0.5 [symbol] /$ because of several intermediaries in the end-to-end payment chain. If using a credit card, a consumer or customer needs to enter data relating to his/her credit card account, typically entering between 80 and 100 characters. An alternative to using a credit card includes using secure identification (secure-ID) devices which tend not to be carried around for fear of misplacing them and are typically used in the home of the consumer.

A further alternative to both credit cards and such secure-ID devices is to redirect the consumer or customer to another website where they need to log in with dedicated user identification (user-ID) credentials and passwords which need to be remembered. In addition, a consumer or customer tends to lose his/her privacy during the transaction process. Moreover, wherever a bank or credit card is used, the consumer or customer has an increased risk of fraudulent use of his/her cards if the electronic network has insufficient security.

In each of these types of transactions, the identification of the consumer or customer making the transaction needs to be verified before payment is completed and the item to be purchased delivered.

### SUMMARY OF THE INVENTION

It is therefore an object of the present invention to provide a method of validating a transaction without disclosing any information about the consumer or customer wishing to make the transaction.

It is a further object of the present invention to provide a method of validating a transaction in which the minimum amount of information needs to be transmitted to enable payment to be made.

It is another object of the present invention to allow transactions to be seamlessly performed from the point of view of a customer.

In accordance with a first aspect of the present invention, there is provided a payment processing system for processing a payment transaction, the system comprising:—

a first entity tendering payment in said payment transaction for at least one item;

a second entity receiving payment from said first party in said payment transaction in return for supplying said at least one item; and

a third entity having a trust relationship with both said first and second parties and through which said payment transaction is to be facilitated;

characterised in that said third entity comprises an environment for transferring and storing electronic representations of at least one medium of exchange for transactional purposes;

and in that said third entity validates said payment transaction in accordance with unique identity information provided to it by both said first entity and said second entity, said first entity being represented as an alias for authentication purposes.

In this way, the transaction is validated and authenticated without the second entity being aware of the identification of the first entity.

Preferably, said third entity further comprises at least one first entity profile relating to said first entity and at least one second entity profile relating to said second entity within said environment, said unique identity information of said first and second entities being stored in respective ones of said first entity profile and said second entity profile.

In addition, said third entity comprises at least one wallet associated with each entity profile.

In an embodiment, said payment transaction comprises transferring at least one medium of exchange between a first entity wallet and a second entity wallet. In this embodiment, said each medium of exchange may be represented in electronic format and an electronic representation of said medium of exchange is transferred between said first entity wallet and said second entity wallet.

In this embodiment, said alias of said first entity is provided by a fourth entity, said first entity being associated with said fourth entity. In this case, said fourth entity interacts with said third entity during authentication to confirm said first entity identity for said second entity. Fourth entity information may form part of a mapping table within said environment, said mapping table linking said fourth entity information to said first entity profile. In this case, said mapping table may link said fourth entity information to one of said first entity wallets within said first entity profile.

In addition, information relating to said fourth entity may be stored in said first entity profile within said environment.

In a preferred embodiment, said fourth entity comprises a social network.

### BRIEF DESCRIPTION OF THE DRAWINGS

For a better understanding of the present invention, reference will now be made, by way of example only, to the accompanying drawings in which:—

FIG. 1 is a block diagram providing an overview of a transaction system in accordance with the present invention;

FIG. 2 is a simple block diagram illustrating the four main elements in a transaction system in accordance with the present invention;

FIG. 3 is intentionally left blank.

FIG. 4 is a block diagram illustrating customer/merchant/broker interaction in accordance with an embodiment of the present invention where the alias is provided by a fourth party;

FIG. 5 is a schematic illustration of a newspaper website from which a customer wishes to obtain an article;

FIG. 6 is similar to FIG. 5 but includes a validation window within the newspaper website;

FIG. 7 is a schematic illustration of the validation process;

FIG. 8 is similar to FIGS. 5 and 6 but illustrating the full article after a validated payment has been made;

FIG. 9 is intentionally left blank;

FIG. 10 is intentionally left blank;

FIG. 11 is intentionally left blank;

FIG. 12 is a schematic illustration of the relationship between a customer, merchant or supplier, a broker and an external identity provider;

FIG. 13 illustrates a block diagram of a validation process in accordance with the present invention; and

FIG. 14 is similar to FIG. 13 but illustrates an authentication process forming part of the validation process in more detail.

### DESCRIPTION OF THE INVENTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes.

In accordance with the present invention, a transaction occurs when a customer provides an indication that he/she has the intention to pay to a merchant or supplier for a particular item. He/she does not need to disclose his/her identity and only needs to provide the minimum of information required to make the transaction. The supplier transfers this minimum information to a broker who makes the actual payment between the supplier and a customer ‘wallet’ within his/her system using an alias which is linked to either the identity of the customer or his/her ‘wallet’.

In this invention the customer indicates to the supplier that he/she wishes to use an external identity provider as a 4^{th} party and that the broker should interact with that 4^{th} party to obtain the alias.

The broker maintains a profile for each customer and for each merchant or supplier. In addition, within each profile, at least one ‘wallet’ is provided from which payment is made in the case of customers and to which payment is made in the case of merchants or suppliers.

In accordance with the present invention, a medium of exchange (MoE) is used for the transfer of payments between a customer and a merchant or supplier via the broker. The MoE can be real money, virtual money, vouchers, etc., and includes anything that can represent some sort of value and can be represented as a data structure. The MoE is transferred to the merchant or supplier in a secure way. This will be described in more detail below.

Elements or features described below which are the same in each of the Figures have the same reference numerals wherever they occur.

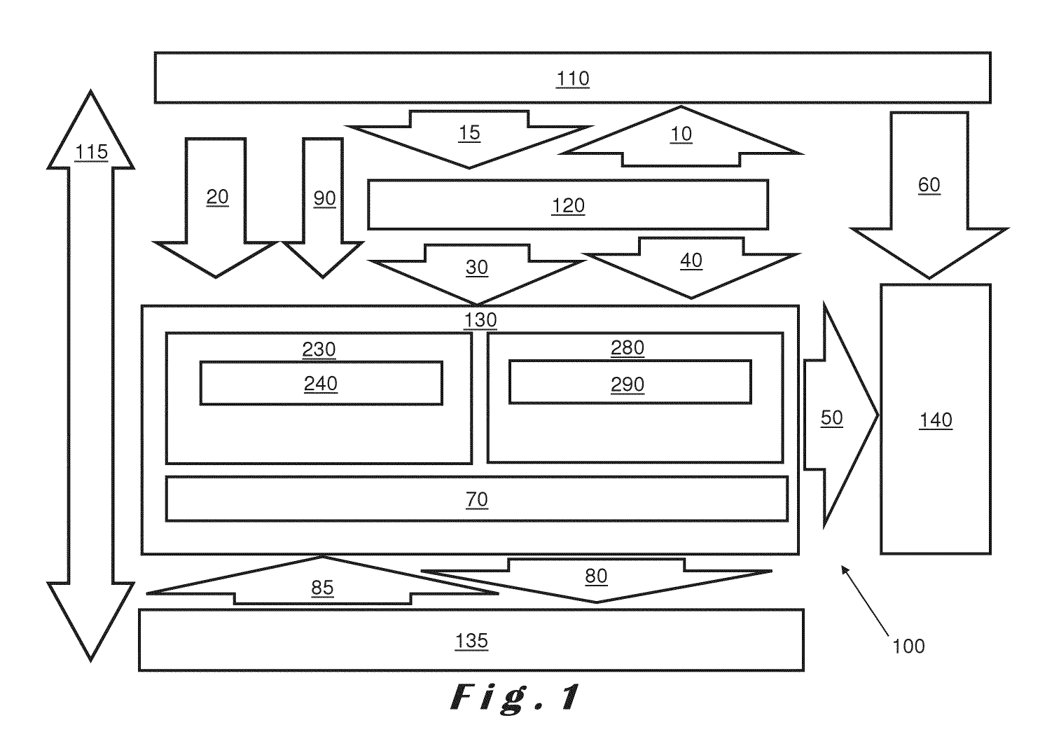

FIG. 1 illustrates an overview of a transaction system 100 in accordance with the present invention, and comprises a customer 110, a merchant or supplier 120, a broker 130 and an external identity provider (EIP) 140. The source 135 of MoE is linked to the customer 110 via an electronic network 115, for example, the internet, a mobile network, a virtual private network (VPN) etc.

The customer 110 can interact with the merchant or supplier 120 so that payment is made through the broker 130 whilst maintaining the anonymity of the customer 110. In this case, the merchant or supplier 120 sends a request to the broker 130 for validation and/or authorisation for the payment, as indicated by arrow 40 as will be described in more detail below. The broker 130 requests the identity of the customer 110 from the EIP 140, as indicated by arrow 50, the customer 110 having previously provided his/her identification to the EIP 140 as indicated by arrow 60.

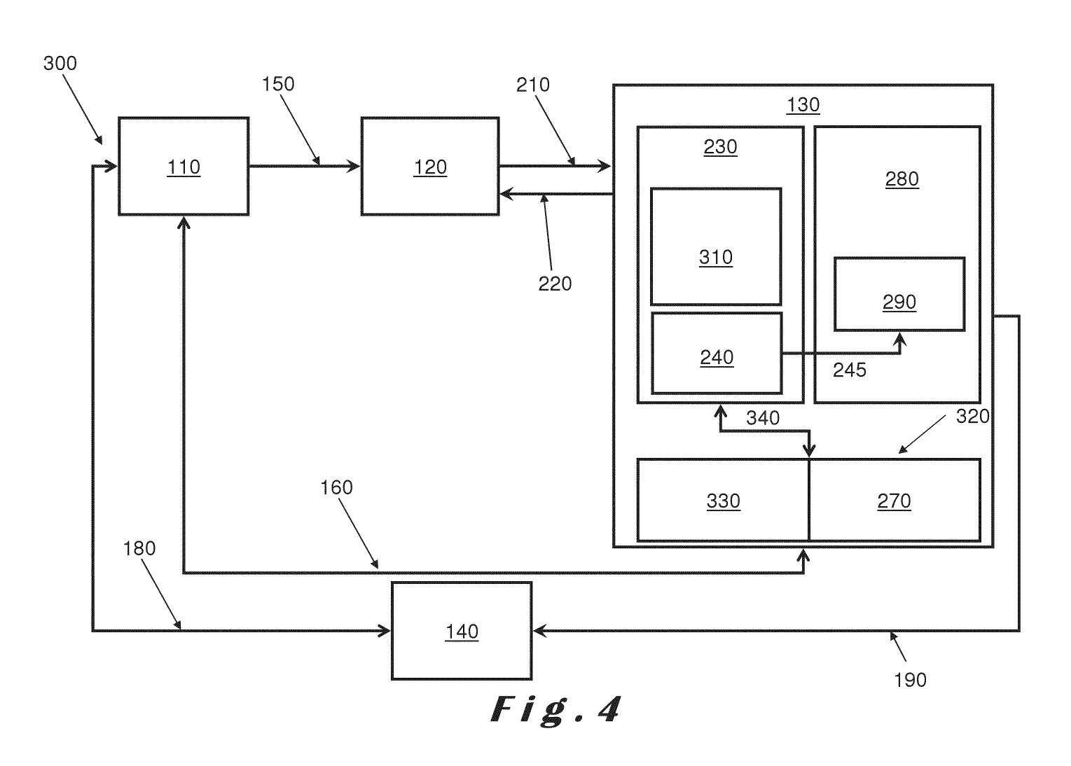

The broker 130 maintains a customer profile 230 and a merchant or supplier profile 280 as will be described below in more detail with reference to FIG. 4. Each profile 230, 280 has an associated wallet 240, 290 into which and from which MoE can be transferred as part of the transaction. In addition, the broker 130 has global referential and transaction facilities 70 which permit the transfer of MoE to and from the source of MoE 135 as shown by arrows 80 and 85 respectively. In addition, transactions are facilitated between ‘wallets’ inside the broker 130 (not shown).

Additionally, the customer 110 can manage his/her customer profile 240 with the broker 130 as shown by arrow 90.

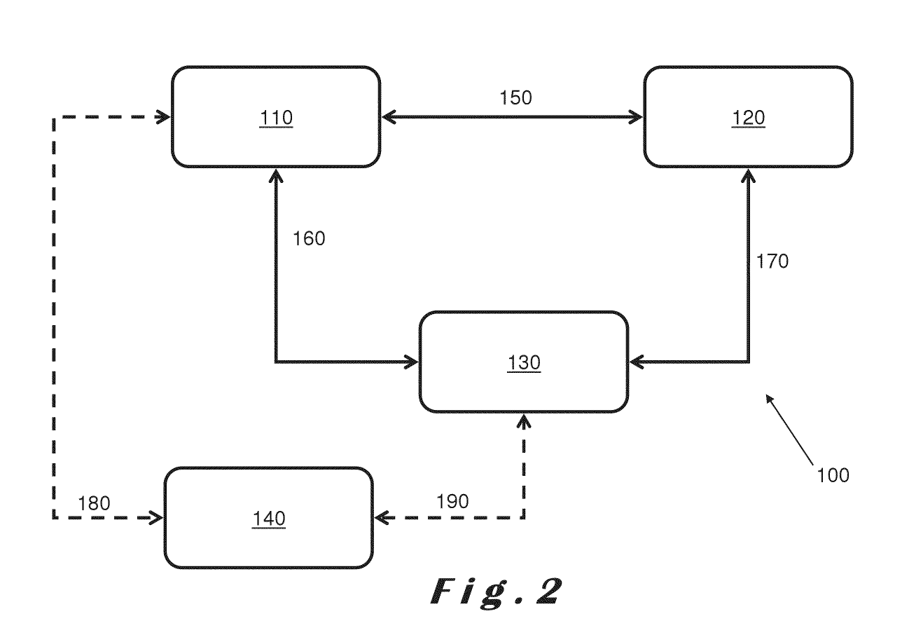

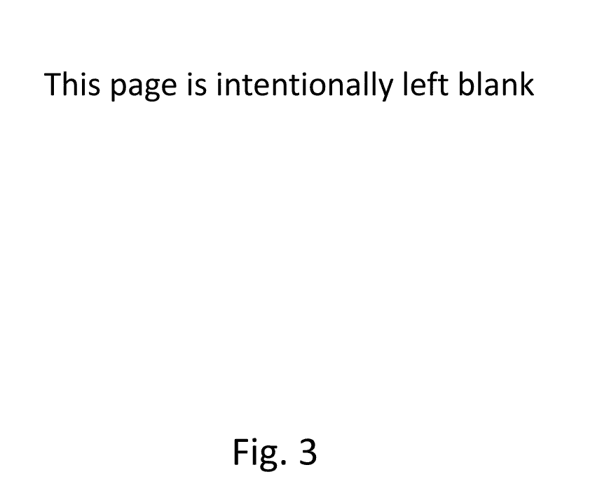

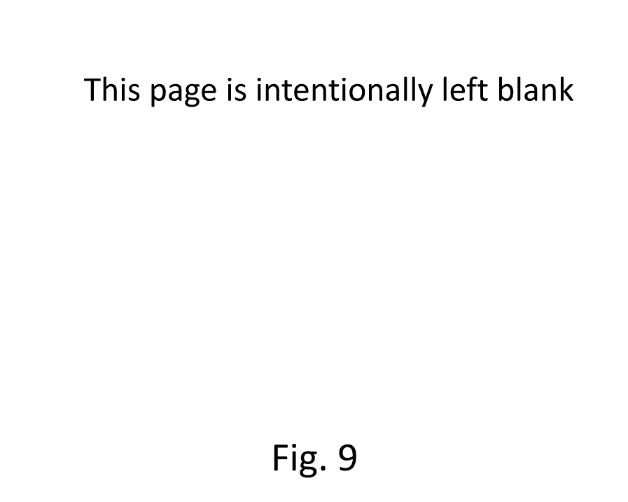

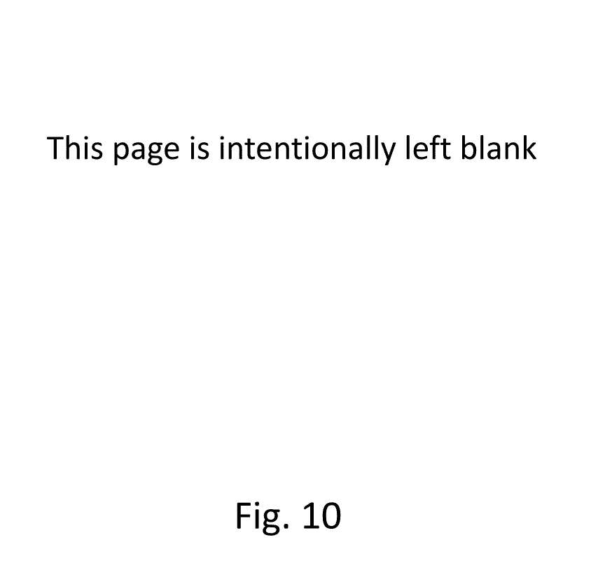

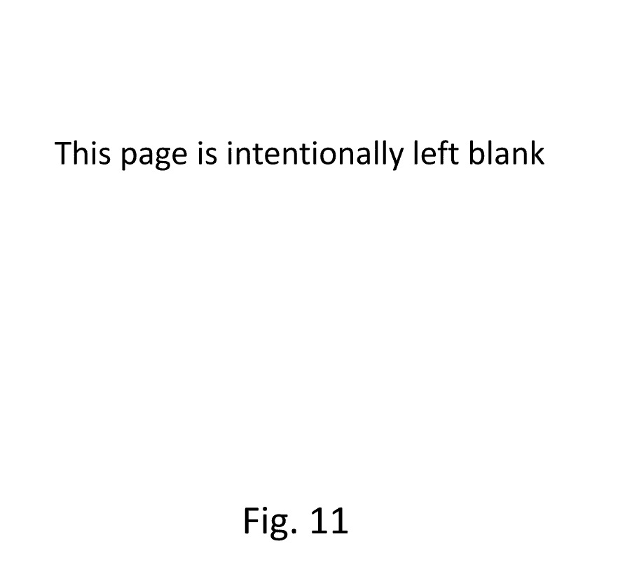

Each part of the transaction system 100 will now be described in more detail with reference to FIGS. 2 to 14 below.

In FIG. 2, a block diagram is shown that illustrates the interactions between four parties when using one embodiment of a transaction system 100 in accordance with the present invention. The system 100 comprises a first party, a customer 110; a second party, a merchant or supplier 120; a third party, a broker 130; and a fourth party, an external identity provider 140.

The customer 110 is the party that wishes to procure goods and services from the merchant or supplier 120, and the merchant or supplier 120 is the party that provides the goods and services to the customer 110 on payment for those goods and services. The customer 110 accesses the merchant or supplier 120, as indicated by arrow 150 over an electronic network and provides a transaction enabler as part of the payment process for the goods and services to be procured from the merchant or supplier 120. The transaction enabler is the means by which the customer 110 indicates the willingness to pay the merchant or supplier 120 who can use it to initiate a transaction within the broker 130.

The broker 130 is the party who brings customer 110 together with the merchant or supplier 120 by providing a capability for each customer to store MoE in a ‘wallet’ with the broker 130, as indicated by arrow 160, and for the merchant or supplier 120 to have MoE transferred into his/her ‘wallet’, as indicated by arrow 170. As both the customer 110 and the merchant or supplier 120 have accounts with the broker 130, the broker 130 provides a mechanism for transferring MoE from a customer ‘wallet’ to the merchant or supplier ‘wallet’ when a customer wishes to pay for goods and services.

The customer 110 accesses the broker 130 to manage his/her profile, to add MoE to his/her ‘wallets’, and to provide an alias as his/her transaction enabler. The merchant or supplier 120 accesses the broker 130 to manage his/her profile and to perform payment transactions with the alias provided by the customer 110.

As an alternative, the customer 110 may interact directly with the broker 130 to transfer MoE to the merchant or supplier 120 himself/herself via the broker 130.

The external identity provider 140 is the party that has a trust relationship with both the customer 110 and the broker 130 as indicated by arrows 180 and 190 respectively. The external identity provider 140 provides an alias representing the customer 110 to the broker 130, which the broker 130 can use to identify the customer 110 (or customer ‘wallet’) in his own system to initiate the payment transaction.

In FIG. 4, a block diagram illustrating the embodiment of a transaction system 300 where an external identity provider is required. The transaction system 300 comprises the customer 110, the merchant or supplier 120, the broker 130, and the external identity provider 140. The customer 110 is connected for interaction with the merchant or supplier 120 as shown by arrow 150, with the broker 130 as shown by arrow 160, and with the external identity provider 140 as shown by arrow 180.

The external identity provider 140 comprises an external party, for example, a social network, such as, Twitter, Facebook, Google+, Yahoo!, LinkedIn, Windows Live etc., which provides an alias to the broker 130 without providing the identity of the customer 110 to the merchant or supplier 120. [Twitter is a trademark of Twitter Inc.; Facebook is a trademark of Facebook Inc.; Google+ is a trademark of Google Inc.; Yahoo! Is a trademark of Yahoo! Inc., a multinational internet corporation; LinkedIn is a business-related social networking site; and Windows Live is a collective brand name for a set of services and software products from Microsoft Inc. that form part of their software plus services platform.]

The customer profile 230 includes, in addition to at least one customer ‘wallet’ 240 having a unique ID, an external identity provider alias 310 which is mapped to the profile/‘wallet’ ID 270 in a mapping table 320. The customer profile 230, and in particular the customer ‘wallet’ 240, is linked to the mapping table 320 as indicated by arrow 340.

In the transaction system 300, the customer 110 signals to the merchant or supplier 120 electronically, for example, over a web-based application or a mobile app, that he/she intends to pay for an item or an article, as indicated by arrow 150, and the merchant or supplier 120 transfers this intention, together with his own identity and transaction details to the broker 130, as indicated by arrow 210. The broker 130 then obtains authorisation for payment by instructing the customer 110, as indicated by two-way arrow 160.

Once authorisation for payment has been received from the customer 110, the broker 130 then retrieves an alias from external identity provider 140, as indicated by arrow 190. This alias was previously registered in the external identity provider alias 310 as part of the customer profile 230, and is linked to the customer ‘wallet’ 240 at the broker 130.

When the broker 130 receives the alias, he/she matches it to the customer profile or ‘wallet’ ID 270 using mapping table 320, and initiates a payment from the customer ‘wallet’ 240 to the merchant or supplier ‘wallet’ 290 as indicated by arrow 245. When the transaction has been completed, the broker 130 provides confirmation, as indicated by arrow 220, to the merchant or supplier 120 who then provides access to the item or article to the customer 110.

From the point of view of the customer 110, the validation process appears to be seamless—as if he/she has not left the web page or mobile app associated with the merchant or supplier 120.

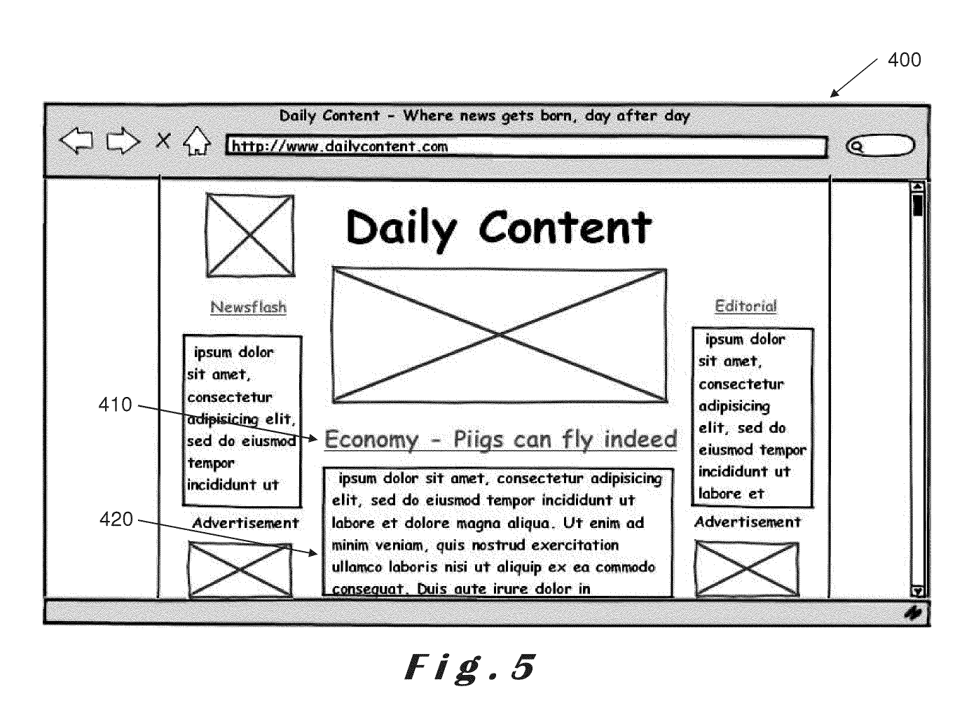

FIG. 5 illustrates an example of web page 400 including an ‘article’ 410 that can be bought from the merchant or supplier of the website. The ‘article’ 410 is presented together with as a teaser paragraph 420 shown to entice a visitor to the website 400 to make a decision as to whether he/she wants to purchase the full ‘article’ 410.

Although a newspaper story is shown as the ‘article’ to be purchased, it will be appreciated that the present invention is not limited to newspaper stories and can include the purchase of a song, a video, an in-game virtual good, access to online software functionality or any other type of good, both online and offline. In the latter case of an offline good, a representation of payment information needs to be transferable to an online format, for example, by scanning a bar code, to make the payment transaction online. In addition, the present invention is not limited to the purchase of goods but can also apply to services.

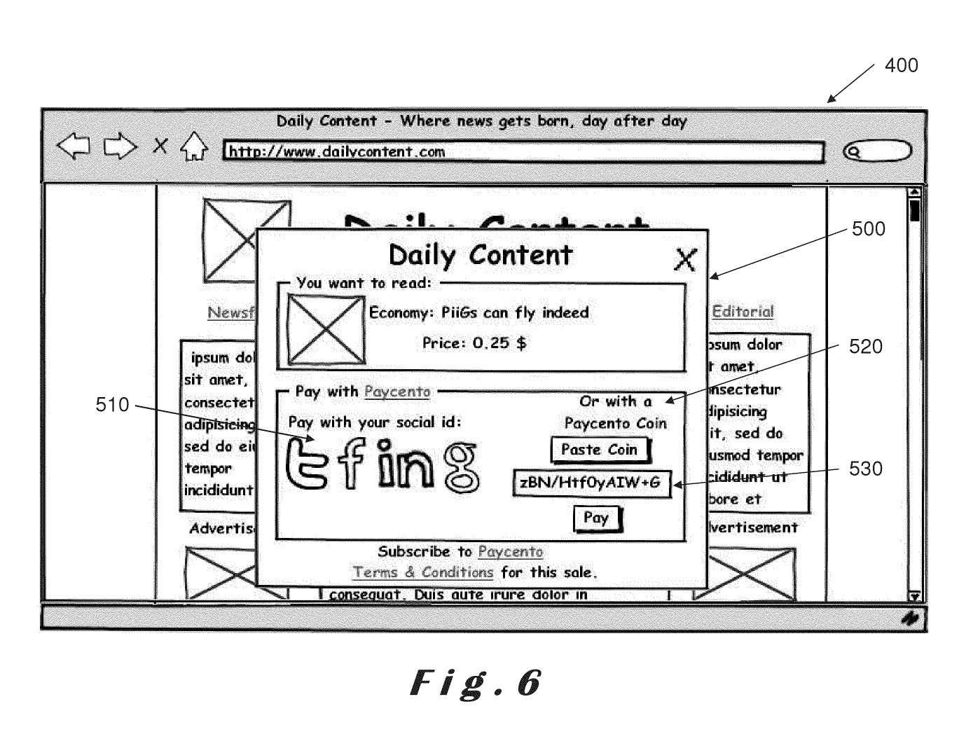

In FIG. 6, an example of a payment screen 500 within the website 400 is shown. The payment screen 500 illustrates how the payment options can be presented to the customer by the merchant or supplier, when trying to access the full article, and where both the choice of paying with a social ID 510 (as described above with reference to FIG. 4) or paying with another method 520 & 530, not part of this patent application.

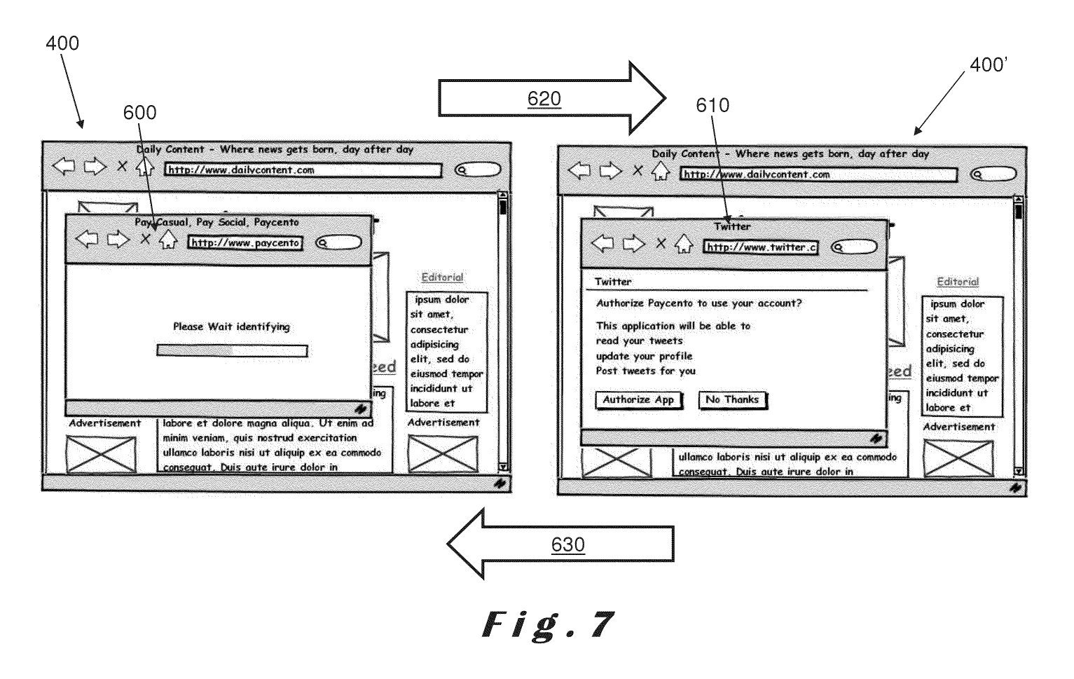

FIG. 7 illustrates two stages in the payment by social ID, by clicking the social ID icon 510 as shown in FIG. 6, as it appears to a customer using the website 400. Selection of payment by social ID opens a broker pop-up window 600 which sits on top of the web page 400 of the merchant or supplier which shows a progress bar of the transaction at the broker (as shown on the left-hand side of FIG. 7). As described above, the broker coordinates the authentication between customer and the external identity provider, in this case, a social network.

This broker pop-up window 600 is then replaced with a pop-up window 610 of the social network 610, as indicated by arrow 620 and shown on the right-hand side of FIG. 7. This provides an opportunity by the social network to obtain credentials from the customer in one of three ways, namely: by prompting explicitly for credentials like user ID and password for the social network; or by getting these credential implicitly, for example, by means of a ‘cookie’ placed by the social network in an earlier session on the device of the customer; or by direct integration of the social network, Twitter™ for example, into the address book, or otherwise, of the device used as in some smartphone operating system implementations. This latter case appears to the customer as a seamless logon.

In the example shown in FIG. 7, the social network asks for authorisation by the customer to use his/her account for the authentication and validation of the transaction. This is optional and dependent on the policy installed by the social network.

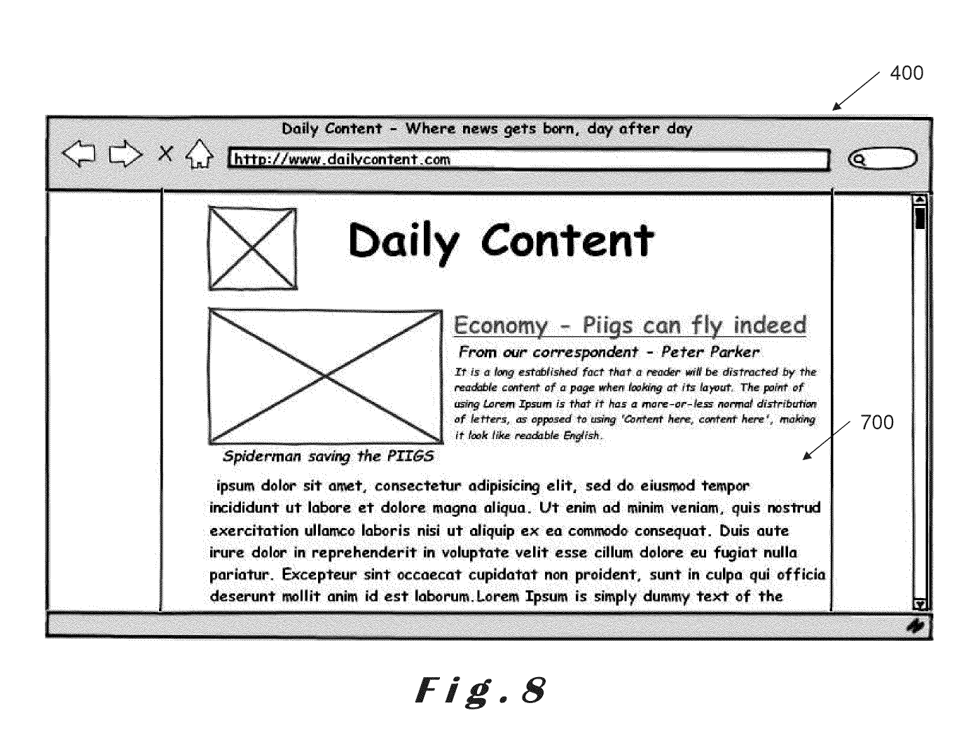

After authentication and authorisation by the social network has been communicated to the broker, the pop-up window 610 of the social network is replaced again by the broker pop-up window 600 as indicated by arrow 630 and shown on the left-hand side of FIG. 7. During this time, the broker has obtained an alias or identity key for the customer from the social network and uses this identity key to complete the payment transaction in the background. When successful, the broker informs the merchant or supplier and hands control back to the browser window to the merchant or supplier web page which then provides a full version 700 of the article, as shown in FIG. 8, when he/she receives a message indicating that the payment was successful.

In another example, the interaction between customer, broker and external service provider may be shown inside the equivalent of an iFrame inside the merchant or supplier web application. However, it will be appreciated that it may also be the case that the interaction is completely transparent and invisible to the customer.

As described above, in the broker, users, for example, customers, merchants and broker representatives, are each identified by a unique broker internal user identifier and is used internally only by the broker. These unique broker internal user identifiers may be implemented by unique user IDs (UUIDs). Such a UUID is linked to one or more unique public user identifiers managed by the broker, for example, but not limited to, a username, a telephone number, a unique alphanumeric code, a fingerprint representation, an email address, which is stored by the broker.

Linked to the broker-managed identifiers are also external alias identifiers which are managed by an external party with which the user identifies himself/herself when engaging with the broker for payment transactions as well as for interacting directly with the broker. Examples of external identity providers include Facebook™, Twitter™, Google+™ LinkedIn™, Yahoo!™, Windows Live™ etc. When a user indicates to the broker that he wants to use a supported external identity provider, an alias of this external identity is linked to the identity of the user managed by the broker and is stored in his/her profile as described above with reference to FIG. 4.

As described above with reference to FIG. 4, a profile contains all information about customers and merchants or suppliers that utilise the services of the broker. For a customer, the profile is uniquely identified by a numeric identifier, the profile ID. For a merchant or supplier, the profile is also uniquely identified by a number identifier, the merchant or supplier ID. Each profile provides reporting capabilities for all changes and transactions done within that profile.

As described above, each profile is linked to a ‘wallet’ which contains a MoE which can be divided over one or more currencies. The MoE cannot exist in more than one ‘wallet’ at the same moment, and is therefore either in the customer ‘wallet’ or in the merchant or supplier ‘wallet’.

One or more customer ‘wallets’ can be created when a profile is initially created by a customer, and therefore each customer profile can be linked to more than one ‘wallet’. Each ‘wallet’ is uniquely identified by a numeric identifier, the customer ‘wallet’ ID when referred to by the broker internally. Only one customer can be owner of a particular customer ‘wallet’, but more than one profile, and hence different customers, can be linked to a ‘wallet’. The MoE in a customer ‘wallet’ acts as a pool from which payment can be made. ‘Wallets’ can be grouped into logical customer ‘wallet’ groups for management purposes.

It is possible to attach information to customer profiles indicating that they are linked to ‘wallets’ or ‘wallet’ groups and which allows the transfer of MoE from outside the broker to “wallets’ created inside without having to re-enter all required data, for example, credit card data, or bank information. It is also possible to attach ‘transfer rules’ to ‘wallets’ and/or ‘wallet’ groups which determine under which conditions MoE is transferred from/to the ‘wallet’ to/from outside the broker system. These ‘transfer rules’ may consist of, but are not limited to, value of MoE passing a threshold, periodic transfers of MoE, and periodic limits.

A customer ‘wallet’ can be loaded using different mechanisms, for example:
By MoE transfers from a customer bank ‘wallet’ to the broker bank ‘wallet’ using the ‘wallet’ ID as an identifier;
By charging of a customer credit or debit card while the customer is logged on to his/her profile on the broker website—the ‘wallet’ ID may be given as an identifier for the credit or debit card processor so that the confirmation message from the latter allows the broker to know which ‘wallet’ has been topped-up;
By sending an SMS with the ‘wallet’ ID and a MoE value to the SMS number of the broker—the mobile phone operator will add the MoE value to the customer phone bill and transfer the funds to the broker ‘wallet’ with the ‘wallet’ ID as identifier;
By registering the customer mobile phone number in his/her broker profile and by sending an SMS with his/her phone number and the MoE value to the premium SMS number of the broker who interacts with the mobile phone operator to bill the customer accordingly;
Through other payment mechanisms like pre-paid cards whose ‘tag’ is entered in the customer profile—the broker will use the ‘tag’ numbers to collect the money from the pre-paid card vendors;
By linking the ‘wallet’ with a financial service provider, or a telecom operator allowing the ‘wallet’ to become ‘overdrawn’ and which is replenished at a later date—in this way, a credit facility is provided;
By scanning the QR codes or copying voucher codes from a merchant or supplier, who distributes virtual money as MoE this way—this transfers the virtual money from the merchant or supplier to the customer, who can then use this virtual money with the merchant or supplier (or one of the affiliates of the merchant or supplier) to access or obtain discounts to articles provided by the merchant or supplier;
Through cash exchange with a broker representative; and
Through integration with other electronic payment providers that exchange MoEs.

It will be appreciated that other transfer mechanisms are also possible.

Customer ‘wallets’ can transfer MoEs outside the broker system to a financial intermediary, for example, a bank ‘wallet’.

In addition, ‘wallets’ or ‘wallet’ groups may contain rules that dictate when and how much MoE can be drawn from each ‘wallet’. It provides the customer with the ability to set limits on the usage of the ‘wallet’, for example, to set maximum amounts that can be drawn from the ‘wallet’ per day/week/month, per transaction, identify the counterparty that can be paid through the ‘wallet’, etc. Two keys are generated when creating the ‘wallet’ and which are used as an identifier of the ‘wallet’ in transactions: the public key and the private key. It is possible to transfer MoE from one ‘wallet’ to another ‘wallet’, where both ‘wallets’ are owned by the same customer. Alternatively, the MoE can be transferred by another customer or merchant or supplier having a profile with the broker. The public key of the ‘wallet’ serves to identify the ‘wallet’ to which money is to be transferred and is available to all interested parties. The private key is used to identify the ‘wallet’ from which money is transferred, and is only known to the broker.

An alias can be used in the payment transaction delivered by an external or 4^{th} party apart from the group comprising the customer, the broker and merchant or supplier. This maintains intrinsically customer anonymity with respect to the merchant or supplier as it is the external party that delivers the alias to the broker which is used to make the payment. By using an alias to enable the transaction, the merchant or supplier only initiates the payment transaction on behalf of the customer with the alias provided by the external party with the permission of the customer.

As described above with reference to FIG. 2 above, the EIP 140 has a trust relationship with both the broker 130 and the customer 110. Typically, the customer 110 creates his/her trust relationship with the EIP 140 by registering with a user ID and password at the EIP website. Typically, the broker 130 creates his/her trust relationship with the EIP 140 by registering with a user ID and password at the EIP 140 and receives a shared secret key to be used in future network-based interactions. The EIP 140 and the broker 130 may use two factor authentication or other cryptographic means.

The customer 110 has also a trust relationship with the broker 130 by registering a private user ID (PUI) with the broker 130 and providing the EIP alias of his identity at the EIP 140. After logging onto the website or application of the broker 130, the customer indicates that a registration with a specific EIP 140 with which the broker 130 has created a trust relationship, must be used. The broker 130 starts an interaction with the EIP 140 using the shared secret key and which requires the customer, at some point, to authorise this by providing his credentials explicitly, for example, user ID and password, or implicitly, for example, through a cookie that the EIP 140 has set earlier in the browser of the customer 110, or by accessing a local secure element that stores the EIP credentials. The combination of broker credentials, the shared secret key in this case, and customer authentication and authorisation will make the EIP 140 expose the customer alias to the broker 130 which is then stored in the customer profile, as described with reference to FIG. 4 above, and link with the PUI, or with the customer ‘wallet’.

In another embodiment, the registration may be performed when trying to buy something from the merchant or supplier using the particular EIP 140 for the first time. In the interaction initiated by the merchant or supplier 120, the broker 130 initiates an interaction with the EIP 140 and, after authorisation by the customer 110, obtains the alias. However, as this alias is not yet present in the mapping table 320 (FIG. 4), the broker 130 asks the merchant or supplier 120 to request the customer for a public user identifier (PUI). After the customer 110 submits this, the merchant or supplier 120 sends it to the broker 130 who will send out an email or equivalent communication to the customer 110 associated with the PUI. The customer 110 clicks on the URL and initiates an EIP alias registration procedure as described above.

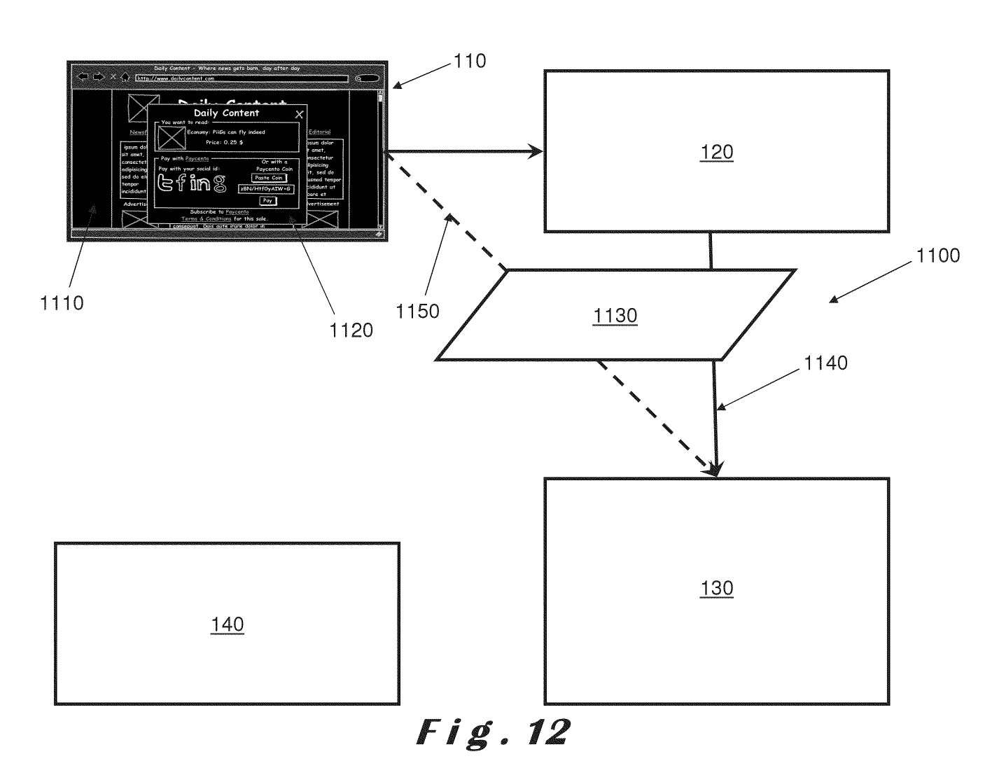

FIG. 12 shows a transaction system 1100 illustrating the relationship between a customer 110, a merchant or supplier 1120, a broker 1130, and an EIP 140 in which the transaction is initiated using the use of the EIP as a fourth party. The customer 110 is shown visiting a merchant or supplier website 1110 so that he/she can access an online article or service. When the article or service requires payment, a payment box 1120 is provided for him/her to select the requested EIP 140 for use in payment. This selection is performed by clicking on the social network as described above with reference to FIGS. 6 and 7. In one embodiment, the payment box 1120 may be generated by a plug-in provided by the broker 130 to the merchant or supplier 120 and contains all necessary information and protocols to participate in the transaction. In another embodiment, the merchant or supplier 120 may create its own plug-in following application programming interface (API) specifications provided by the broker 130.

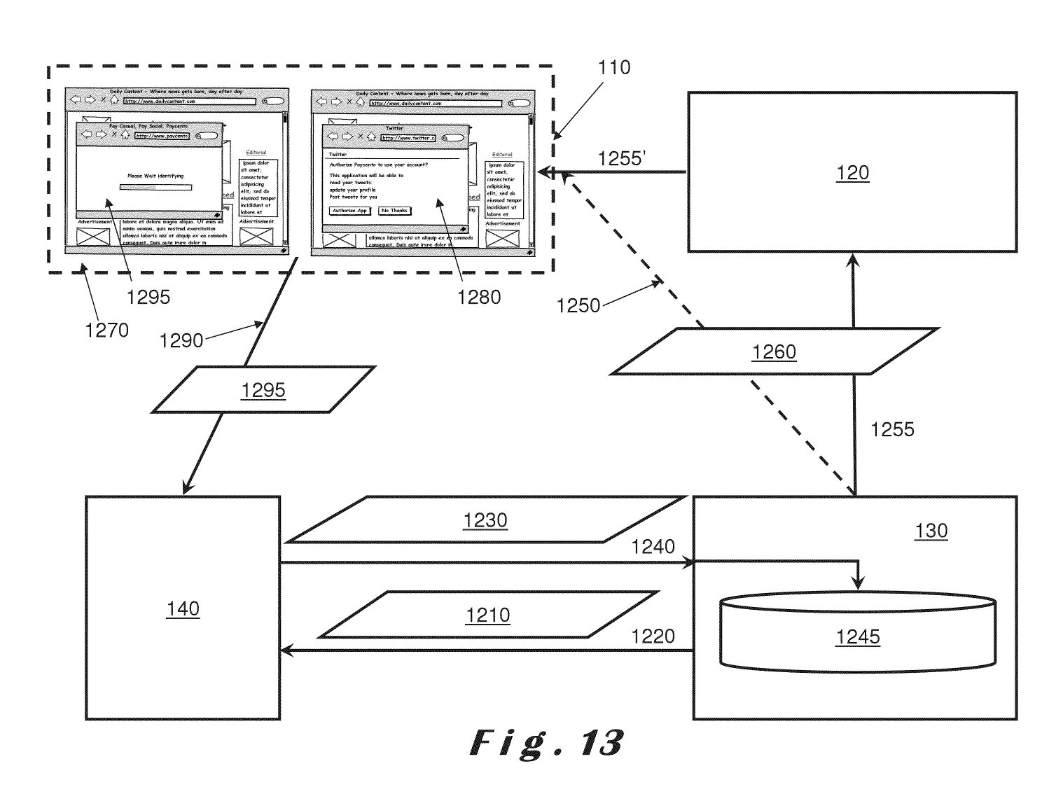

The merchant or supplier 120 sends a message 1130 with his/her own identity information, as indicated by arrow 1140, which may be, in one embodiment, the merchant or supplier ‘wallet’ public key, with which the broker 130 can credit the merchant or supplier ‘wallet’. In one embodiment, this may be performed directly from the customer client application, for example, a web browser or mobile application 1110, as indicated by 1150 where the merchant or supplier 120 provided the necessary data to the client beforehand. In another embodiment, this may be performed from the merchant or supplier application itself as indicated by 1140. The broker 130 determines if he/she needs to get the alias of the customer 110 from the EIP 140 and initiates the specific protocol to communicate with the EIP 140. This is described in more detail below with reference to FIG. 13. General transaction information, from the merchant or supplier, for example, price in MoE, article ID, description, etc., and the name of the EIP 140 to the broker 130 is also included in the message 1130.

In FIG. 13, a generic example of a validation process 1200 in which the first step of the authentication between broker 130, customer 110 and EIP 140 is shown. The broker 130 obtains a first transaction specific alias that is linked to the identity of the broker 130 with the EIP 140 and which needs to be passed back to the customer, the EIP 140 being used to find and validate the customer alias. A specific protocol, the ‘Oauth’ protocol, is utilised as shown. This protocol exists in many versions and is the de-facto standard used by social networks, such as, Facebook™, Yahoo!™, LinkedIn™, Twitter™, Windows Live™ and Google+™.

The broker 130 uses, in this example, the shared secret key 1210 between the broker 130 and EIP 140 over a secured network channel, for example, a secure socket layer (SSL), to the EIP 140 together with other necessary information the EIP might require as indicated by arrow 1220. The EIP 140 identifies the broker based on the shared secret key 1210 and answers with a request token 1230 that will be used in the authentication with the customer 110, as indicated by arrow 1240. The request token 1230 together with an associated request token secret key is stored by the broker 130 in a database 1245 for this transaction. The database 1245 is an example of computer storage which may also be a memory or a file system.

The broker 130 needs then to connect the customer 110 with the EIP 140 to make the authorisation and retrieve the result. For that he/she needs to provide the customer 110 with the request token, as indicated by dotted arrow 1250, so the EIP 140 understands that the authorisation request is done on behalf of the broker 130. In one embodiment, this can be done by sending the request token together with the ‘callback URL’ pointing back to the broker 130 as well as other required information 1260 back to the merchant or supplier 120 or the customer client application 1270, either directly or through the merchant or supplier as indicated by arrows 1255 and 1255′, and instructing the merchant or supplier 120 or customer client application 1270 to redirect the customer 110 directly to the EIP 140. This can be performed either in the same window or through a separate window 1280.

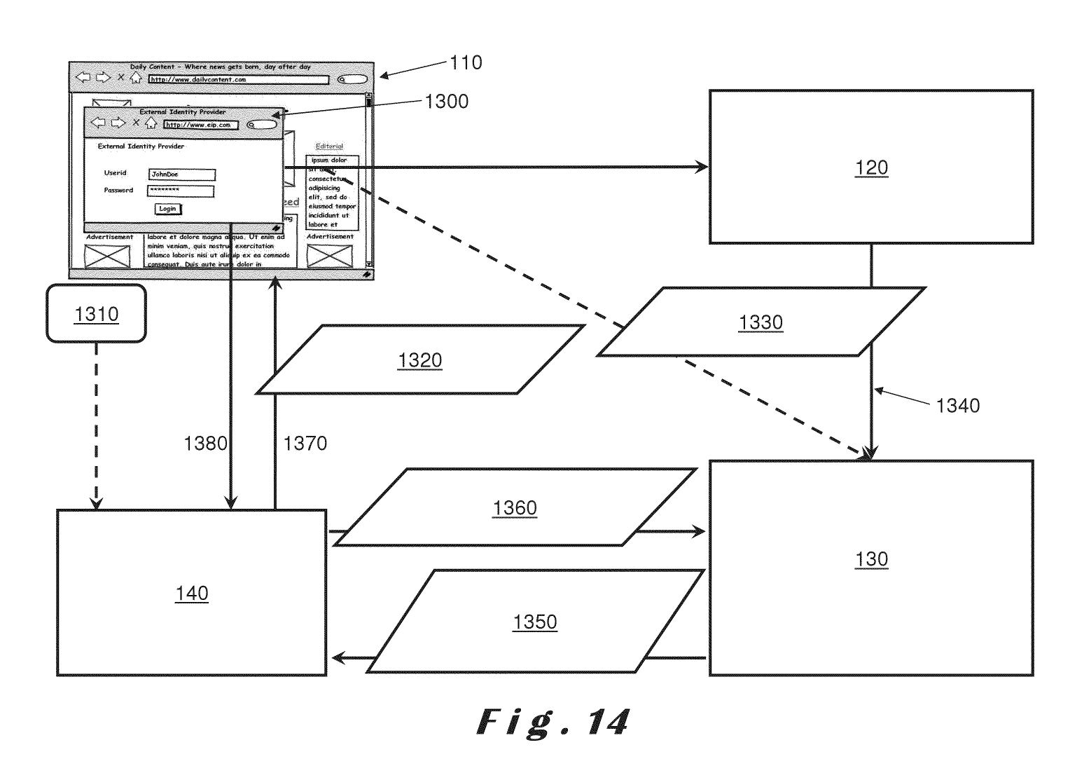

In another embodiment, the broker 130 takes direct control and requests the merchant or supplier 120 or customer client application 1270 to connect to the broker 130 either in the same window, or through a separate window 1285. In this case, it is the broker 130 who redirects the customer client application 1270 to the EIP 140 as indicated by arrow 1290. The customer client application 1270 will provide the request token 1295 and other required information to the EIP 140. The next step is shown in FIG. 14.

In FIG. 14, after the customer client application 1270 has connected with the EIP 140, the EIP will request authentication of the customer 110, in order to make the authorisation. This corresponds to a second part of the authentication process, where the customer 110 uses the first transaction specific alias to obtain a second transaction specific alias linking the identity of the customer 110 with the EIP 140 and which needs to be passed back to the broker 130 to be used by the latter to obtain the static alias of the customer 110 with the EIP 140 and matched with the alias stored by the broker 130. In one embodiment, this authentication is explicit where the customer needs to provide credentials like user ID and password as indicated by box 1300.

In another embodiment, the authentication is implicit because the customer client application 1270, for example, a web browser, provides a ‘cookie’ 1310 that has been set by the EIP 140 on an earlier visit, which authenticates the customer 110 in the background. In yet another embodiment, the authentication is implicit because the customer device or customer client application 1270 has explicit EIP integration, for example, on Apple iPhone having iOS, the Apple mobile operating system. Apple and iPhone are trademarks of Apple Inc.

Once the authentication has been made, the EIP 140 authorises the request based on the request token provided by the broker 130 and the customer authentication as indicated by arrow 1370. In one embodiment, the authorisation is automatic, and in another embodiment, the EIP may explicitly ask the customer 110 to authorise by clicking on a button as described above with reference to FIG. 6, as indicated by arrow 1380. The EIP 140 provides then an authorisation verifier code 1320 that shows the authorisation has been made and redirects the customer client application 1270 to the ‘callback URL’, which is, in one embodiment, to the broker 130, and, in another embodiment, to the merchant or supplier 120. In the latter case, the merchant or supplier 120 sends the request token back the broker 130, together with the authorisation verifier 1330, as indicated by arrow 1340.

The merchant or supplier 120 cannot impersonate the broker 130 with the request token or authorisation verifier, as it has no access to the request token secret key which is needed to obtain the alias of the customer 110. Moreover, the merchant or supplier 120 does not have access to the customer identity as neither the request token nor authorisation verifier provides any information about the customer 110 in isolation.

The broker 130, now in possession of the request token, authorisation verifier and request token secret key has now everything he needs to obtain the alias of the customer 110. The broker 130 generates a signature 1350 using the request token secret key and submits this, together with his shared secret key, the authorisation verifier, the request token and other required information to the EIP 140. The EIP 140 returns the ID of the user at the EIP 140 as well as his screen name and other information 1360.

The broker 130 takes the EIP user ID, and looks up the associated PUI or ‘wallet’ ID of the customer 110. Together with the merchant or supplier ‘wallet’ public key and the other transaction information, the broker 130 can now debit the customer ‘wallet’ and credit the merchant or supplier ‘wallet’ as described above with reference to FIG. 4, while subtracting a broker fee. Once the payment is completed, the broker 130 responds to the merchant or supplier 120 who then enables access to the article for the customer 110 as shown in FIG. 8.

The present invention has been described with reference to specific embodiments and implementations. However, it will be appreciated that other embodiments and implementations are also possible whilst still within the scope of the present invention.

1. A method for authenticating & authorizing transactions using an external alias, over electronic networks comprising:
initiating a transaction, by a first entity sending a transaction request to a second entity comprising:
the type of external alias to use;
any other required transactional information, but not requiring any specific information identifying the first entity to the second entity;
receiving said transaction request by a second entity and generating a new transaction request, sent to a third entity, comprising:
the type of alias the first entity requested;
information identifying the second entity to said third entity;
any other required transaction details;
receiving said new transaction request by the aforementioned third entity comprising:
an environment to create a trust relationship with, and store identity information of the first and second entity;
an ability to create a trust relationship with one or more fourth entities and retrieve one or more aliases of the first entity from said fourth entity and associate them with the identity of the first entity as known by the third entity;
an environment for obtaining, storing and transferring electronic representations of at least one medium of exchange for transactional purposes from the first to the second entity or from the second from the first entity;
initiating an authentication request by the third entity to the fourth entity as indicated in the aforementioned type of alias, and receiving an authentication initiation response from the fourth entity comprising:
a request token, indicating a request for authentication is created by the third entity;
a request token secret key, for future interaction in the authentication process between the third entity and the fourth entity;
instructing by the third entity of the first entity, while passing the request token and other required information excluding the request token secret key, to authenticate itself to the fourth entity as identified by the aforementioned type of alias characterised in that said fourth entity comprises:
an environment that already created a trust relationship with the third entity;
an existing authentication transaction request with the third entity related to aforementioned request token;
existing identity information of the first entity, or a way to register identity information of the first entity;
at least one way for the first entity to authenticate itself to the fourth entity;
authenticating of the first entity to the fourth entity by one of the methods it supports comprising:
userid and password of the first entity;
browser based cookies with authentication information;
authentication information stored in a secure element in the device the first entity uses;
mobile operating system supported integrations of the first entity with the fourth entity;
creating an authentication verifier code by the fourth entity based on the alias of the first entity existing in the fourth entity and the aforementioned request token and returning it to the first entity;
passing of the said authorization verifier code by the first entity to the third entity;
requesting of the identity alias of the first entity by the third entity to the forth entity by sending a message constructed from elements comprising:
request token;
authentication verifier code;
request token secret key;
the trust relationship between the third and the fourth entity;
receiving by the third entity from the fourth entity, after verification of the aforementioned message by the fourth entity, of the identity alias of the first entity as known by the fourth entity as well as other required information;
matching by the third entity of the identity alias of the first entity as received from the fourth entity, with the already stored identity alias of the first entity in the third entity;
performing of the transaction by the third entity between the first entity and the second entity;
informing by the third entity to the second entity of the transaction result of the transaction between the second entity and the first entity;
informing by the second entity to the first entity of the transaction result of the transaction between the first entity and the second entity and optionally providing access to the first entity of the object of the transaction.

2. The method of claim 1 where the fourth entity asks for explicit authorization to the first entity to divulge the first entity's alias to the third entity.

3. The method of claim 1 where the third entity asks for authorization of the transaction to the first entity after it retrieved the alias of the first entity.

4. The method of claim 1 where the environment in the third entity comprises at least one first entity profile relating to said first entity and at least one second entity profile relating to said second entity within said environment, said unique identity information of said first and second entities being stored in respective ones of said first entity profile and said second entity profile.

5. The environment of claim 4 wherein said third entity comprises at least one wallet or account associated with each entity profile.

6. The wallet or account of claim 5 which comprises at least one of the following:
a stored value account storing an amount of real or virtual currencies;
a payment instrument like a credit card or debit card;
a direct debit authorization to a financial account;
a post-paid billing system;
a pre-paid system;
any other system that can provide medium of exchange to facilitate the transaction.

7. The method of claim 6 where there are limits set in the entity profile, account or wallet on performing a transaction, comprising:
the amount of medium of exchange per transaction;
the amount of medium of exchange per time period;
a start date;
an end date;
a specific currency;
a reusability of authorization comprising of: one time, multiple times, per time period;
a specific first or second entity.

8. The method of claim 1 where the result of the transaction comprises at least one of:
transfer of medium of exchange from the first entity to the second entity, or vice-versa;
authorization of access to medium of exchange of the first entity by the second entity, or vice-versa;
transferring identity and other information of the first entity to the second entity;
registering of information from the second entity in the environment of the first entity, or vice-versa;
retrieving of information from the first entity environment by the second entity or vice-versa.

9. The method of claim 1 where the trust relationship between the third entity and the fourth entity comprises at least one of the following:
a shared secret key;
a public-private key pair;
an identity alias of the third entity with the fourth entity.

10. The method of claim 1 where the instruction by the third entity to the first entity to authenticate itself with the fourth entity passes through the second entity.

11. The method of claim 1 where the response by the fourth entity of the authentication of the first entity is passed from the first entity to the third entity through the second entity.

12. The method of claim 4 where the alias of the first entity, retrieved from the fourth entity is linked to the profile of the first entity.

13. The method of claim 5 where the alias for the first entity, retrieved from the fourth entity is linked to a wallet or account of the first entity.

14. The method of claim 1 where the third entity informs the first entity of the result of the transaction between the first entity and the second entity.

15. The method of claim 1 where the fourth entity is a social network.

16. The method of claim 1 where the interaction between the first, third and fourth entity is governed by the oauth protocol.
